(19) United States
(12) Patent Application Publication
(10) Pub. No.: US 2016/0336661 A1
(43) Pub. Date: Nov. 17, 2016

(54) Washer for Establishing Electrical Continuity

(71) Applicant: AIRBUS DEFENCE AND SPACE, S.A.U., Madrid (ES)

(72) Inventors: Antonio Cala Romero, Madrid (ES); Pedro Gil Báez, Madrid (ES); Juan Javier Beltrán Calero, Madrid (ES); Domingo Morales Palma, Sevilla (ES); Carpóforo Vallellano Martín, Sevilla (ES); Gabriel Centano Báez, Sevilla (ES)

(73) Assignee: AIRBUS DEFENCE AND SPACE, S.A.U., Madrid (ES)

(21) Appl. No.: 15/148,122

(22) Filed: May 6, 2016

(30) Foreign Application Priority Data
May 7, 2015 (ES) P201530620

(51) Int. Cl. H01R 4/30; H01R 4/64

(52) U.S. Cl. CPC H01R 4/304; H01R 4/64; H01R 2201/26

(57) ABSTRACT

A washer is designed to establish a reliable electrical connection between the washer and a core structure of the main conductor aircraft structure. The washer includes a conductive central main body arranged substantially in a first plane and including an opening adapted to receive a fastener and an outer edge and at least three serrated conductive projections. Each serrated projection includes a first end and a second end. The first end is attached to the conductive central main body and the second end is a free end including at least one conductive tooth. The second end is located in a second plan other than the first plane and is of the type that can deform under pressure. The attachment between the conductive central main body and each serrated conductive projection is of the type that can deform under pressure.

### FIELD OF THE INVENTION

The present invention relates to a special washer used in the aeronautical industry. In particular, the washer of the invention is intended for establishing a reliable electrical connection between the washer and a structure with a primary conductive core of the aircraft structure.

### BACKGROUND OF THE INVENTION

A washer is a thin (typically disc-shaped) plate with an opening (generally in the center) which is normally used for distributing the load of a threaded fastening element, such as a screw or nut.

In the aeronautical industry, such washers are commonly used to distribute the force made by a fastening on a specific structure. Another additional use of washers is to contribute to providing electrical continuity between the aircraft structure and the attachment elements.

The structure where washers are fastened is usually provided with a surface protection to prevent oxidation of the material of the structure, which is typically non-conductive. This means that the washer cannot establish the electrical conductivity between the attachment elements and the structure. To solve this problem, an operator must descale and clean the contact surface before installing the attachment elements, which involves an economic and time expenditure when making said assemblies.

Patent document U.S. Pat. No. 5,453,027 discloses a solution to this problem. Said patent document describes a washer with sharp prominences the ends of which project from the plane of the main body of the washer. This solution does not assure, however, that there are no gaps between said prominences and the material to which the washer is fastened.

Another solution to this problem can be found in patent document U.S. Pat. No. 6,368,038B1. Said patent document describes a serrated linear device that must be wound around a threaded rod or the like for use. Such serration has as a drawback the fact that deformation (bending) on said serration is not controlled, and therefore the final geometry of the attachment cannot be specified and it cannot be assured that the removed material does not remain under the contact area of the teeth, which can result in problems when assuring electrical conductivity between the rivet and the material of the structure to which said rivet is fastened.

Therefore, there is a need in the aeronautical sector for a washer that allows establishing electrical connectivity between a fastening element and a structure without having to prepare the surface by means of mechanical descaling and subsequent cleaning thereof and minimizing clearances between the washer and the structure.

### BRIEF SUMMARY OF THE INVENTION

In a first inventive aspect of the invention, a washer for establishing electrical conductivity is provided, comprising:

a conductive central main body arranged substantially in a first plane, and comprising

an opening adapted to receive fastening means, and

an outer edge,

at least three serrated conductive projections, in which each serrated projection comprises a first and second end, in which the first end of the serrated conductive projection is attached to said conductive central main body and the second end is a free end comprising at least one conductive tooth,

characterized in that

the second end of each serrated conductive projection is located in a second plane other than the first plane of the conductive central main body of the washer, said second end being of the type that can deform under pressure, and

in that the attachment between the conductive central main body and each serrated conductive projection is of the type that can deform under pressure.

Reference is made throughout this document to the deformable nature of the projecting element and of the at least three serrated conductive projections developed or emerging from same. This means that the deformation said elements undergo in the event of a specific pressure or force exerted on the first plane where the conductive central main body of the washer is located entails that the initial position of the free end of the conductive projection is modified, the attachment between the first end of the conductive projection and the conductive central main body being maintained.

In addition, the nature of each serrated conductive projection implies that it comprises a shape with at least one conductive tooth at its second end. Said conductive tooth emerges or develops from the second end of the serrated conductive projection. Furthermore, the conductive tooth is adapted to scrape any material coming into contact with it, such that it favors material removal. Said material can be, for example, a surface coating or covering of a conductive surface.

Therefore, as a result of the technical features described above, when a force is applied on the first plane of the washer, each serrated conductive projection pulls any surface coating that is in contact with it towards the outer portion of the contact area of the washer, which assures the cleanliness of said area. The deformable nature of the washer, allows obtaining a planar final geometry of the attachment, which minimizes clearances and improves conductivity.

Advantageously, this washer is able to remove any surface coating that may cover the conductive surface where it is going to be located and efficiently and reliably establish electrical conductivity between the washer and the material of said surface to which it is fastened.

In a particular embodiment, the second end of the at least three serrated conductive projections comprises a plurality of teeth.

Advantageously, the plurality of teeth provides an increase in the amount of pulling or contact points of the washer, which entails increasing the areas of the washer acting on the surface or structure where it is going to be located. Therefore, this embodiment makes it easier to remove any surface coating that the conductive surface or structure where the washer is going to be located may have, reducing the force that must be used. The variable geometry which is adaptable to each case of the conductive projection and of the teeth, increases the range of surface coatings on which this washer can be used, allowing it to be used in coatings having a higher or lower hardness.

In a particular embodiment, between the first plane, where the conductive central main body is arranged, and each serrated conductive projection an angle (α) having a value of between 45° and 75°, preferably 60°, is formed.

In a particular embodiment, the angle (α) comprises the same value in each serrated conductive projection.

Advantageously, depending on the angle formed by each serrated conductive projection and on the geometry thereof, the washer is capable of efficiently removing any surface coating that the surface where the washer is going to be located may have, regardless of if said surface has a curvature or concavity, assuring reliable electrical continuity between the washer and the conductive material of said surface.

In a particular embodiment, the at least one conductive tooth comprises a sharp edge, said sharp edge being adapted to scrape a material coming into contact with said at least one conductive tooth. Advantageously, this sharp edge makes it easier to scrape the material, increasing the use efficiency of the washer.

In a particular embodiment, the first end of each serrated conductive projection is attached to the outer edge of the conductive central main body.

In a particular embodiment, the conductive central main body of the washer is metallic.

In a particular embodiment, the serrated conductive projections of the washer are metallic.

In a particular embodiment, the serrated conductive projections and the conductive central main body form a single part.

Structure in the form of a single part or one-piece structure is understood to mean that the structure of the conductive central main body, the serrated conductive projections and the at least one conductive tooth of the serrated conductive projection form a single part. Therefore, the part does not have any welding or attachment connecting the different portions. Advantageously, using a single-part configuration saves in production and material costs when manufacturing the washer.

In a particular embodiment, the conductive central main body comprises an electrically conductive surface coating.

In a particular embodiment, each serrated conductive projection comprises an electrically conductive surface coating.

Advantageously, the use of a conductive surface coating improves conduction between the washer and the conductive structure where the washer is going to be located in those cases in which the conductivity is reduced for any reason.

In a particular embodiment, the first ends of the serrated conductive projections are distributed equidistantly around the conductive central main body.

In a particular embodiment, the thickness of each serrated conductive projection is constant.

In a particular embodiment, the thickness of each serrated conductive projection is variable.

In a particular embodiment, the washer comprises six serrated conductive projections attached to the conductive central main body.

Advantageously, due to the geometry characteristic of the serrated conductive projections (thickness, angle, number and length of the teeth), it is possible to adjust the degree of pulling of material and penetration in the conductive surface according to each case (thickness of the structure or fuselage, materials, dimensions and shape), being able to assure and control electrical conductivity between the elements to be connected.

All the features and/or steps of the methods described in this specification (including the claims, description and drawings) can be combined in any combination, with the exception of those combinations of such mutually exclusive features.

### BRIEF DESCRIPTION OF THE DRAWINGS

The foregoing and other features and advantages of the invention will become clearer based on the following detailed description of a preferred embodiment, provided only by way of illustrative and non-limiting example, in reference to the attached drawings.

FIG. 1 shows a washer according to the present invention in which a serrated conductive projection with a conductive tooth can be seen.

FIG. 2 shows a washer according to the present invention in which a serrated conductive projection with three conductive teeth can be seen.

FIG. 3 shows a cross-section view of a washer according to the present invention.

FIG. 4 shows a cross-section view of a structure and a washer according to the present invention, where said washer is subjected to a crushing force perpendicular to the main plane thereof.

FIG. 5 shows a cross-section view of a washer according to the present invention after having been deformed.

FIG. 6 shows an enlarged view of the attachment between a serrated conductive projection with a single conductive tooth according to the present invention and the conductive structure after the non-conductive coating has been removed out of the contact area.

### DETAILED DESCRIPTION OF THE INVENTION

According to the first inventive aspect of the invention, the present invention relates to a washer adapted to establish electrical continuity between several elements, with a special application in aircraft structures. The final objective of this washer is to scrape any non-electrically conductive coating which is arranged on some electrically conductive surfaces, which are common in the aeronautical industry, and to thereby provide an electrical connection between the washer and said conductive structure to which it has been fastened, in addition to performing the function that any conventional washer performs in the fastening of screws and/or rivets.

FIG. 1 shows a washer (1) according to the present invention. In this embodiment, the washer (1) comprises a conductive element formed by a central portion arranged in a first plane, referred to as conductive central main body (2), which is located in a first plane (7). The conductive main body (2) comprises:
an opening (11) adapted to receive fastening means, such as a screw, for example, and
an outer edge (10).

FIG. 1 shows four serrated conductive projections (3), of the six serrated projections (3) in total that the washer (1) comprises, which serrated conductive projections (3) develop or emerge from the outer edge (10) of said conductive central main body (2) to the first end of each serrated projection (3). In this embodiment, the second end (9) of each serrated conductive projection (3) comprises a conductive tooth (13).

It can be seen that the second end (9) of each serrated conductive projection (3) and the conductive teeth (13) are located in a second plane (8) other than the first plane (7). As a result of this arrangement, the tooth (13) of each serrated conductive projection (3) can scrape and remove any surface coating that the conductive surface where said washer (1) is to be used may have.

In one embodiment, the conductive central main body (2) has a circular shape and the opening (11) has a cylindrical geometry.

In other embodiments, the conductive central main body (2) comprises a circular shape where the opening (11) has a regular or irregular polygonal geometry. Both the geometric shape of the conductive central main body (2) and the geometric shape of the opening (11) can be chosen and combined such that the user can adapt it as needed, for example, for use with a cylindrical-shaped or prismatic-shaped rivet, a threaded screw, a threaded screw with an unthreaded area (usually close to the head of the screw), etc.

As can be seen in the embodiment of FIG. 1, the washer (1) forms a single part, such that the conductive central main body (2), the serrated conductive projection (3) and the conductive teeth (13) are manufactured in one and the same part. This type of manufacture allows saving in manufacturing costs for the washer (1) because it can be manufactured in large amounts using an automatic milling machine.

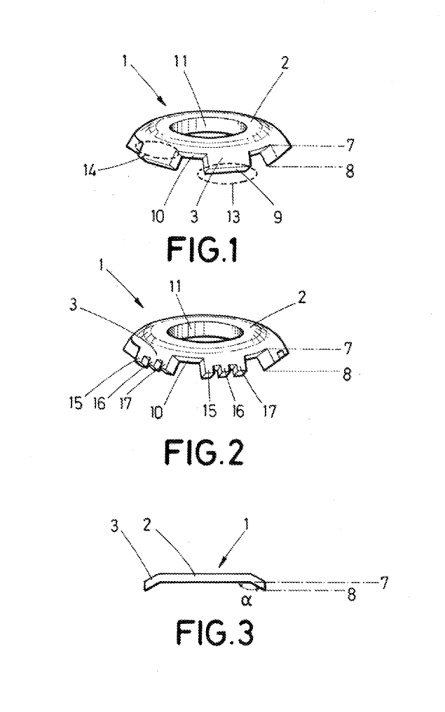

In one embodiment, the second end (9) of each serrated conductive projection (3) comprises at its second end (9) a plurality of uniformly distributed conductive teeth. In particular, FIG. 2 shows an embodiment of a washer (1) in which each serrated conductive projection (3) comprises at its second end (9) three conductive uniformly distributed teeth (15, 16, 17). The arrangement and number of teeth (13, 15, 16, 17) will depend on the properties of the washer material as well as on the type of surface coating covering the structure where the washer (1) is to be located.

Advantageously, the conductive teeth (15, 16, 17) provide an increase in the amount of pulling or contact points of the washer, which implies that there are more areas of the washer (1) acting on the structure or surface where it is going to be located. Therefore, this embodiment makes it easier to remove any surface coating that the conductive surface or structure where the washer is going to be located may have, reducing the force that must be used.

FIG. 3 shows a cross-section view of a washer (1) according to the present invention. It can be seen in this embodiment that an angle (α) is formed between the first plane (7), where the attachment between the conductive main body (2) and the serrated conductive projection (3) is arranged. The value of the angle (α) will depend on the material of the structure and on the surface coating thereof on which the washer is going to be applied. In the event that it is used on a surface with a curvature, each serrated conductive projection (3) will have an angle with a different value in order to be able to more efficiently scrape the non-conductive coating. In this embodiment, the washer (1) is provided for being used on a planar surface, and therefore all the conductive projections have an angle with the same value.

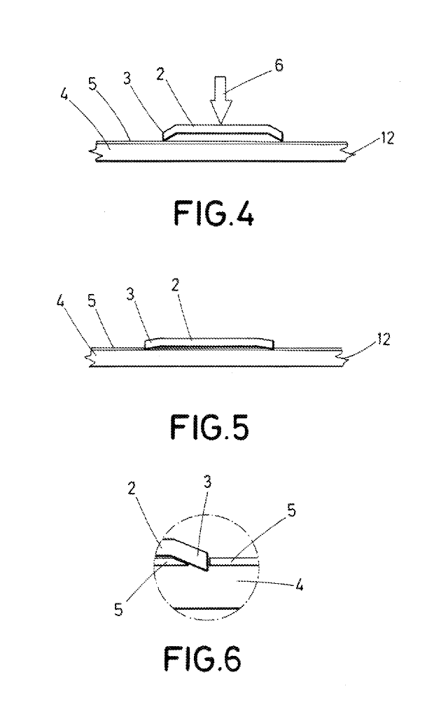

FIG. 4 shows a cross-section view of a structure (12) and a washer (1) according to the present invention, where said washer (1) is subjected to a crushing force (6).

Therefore, in one embodiment a method for establishing electrical connectivity between a fastening element, in this case a washer (1), and a structure (12) with a conductive core (4) and non-conductive surface coating (5) is shown, in which the method comprises:
providing a washer (1), according to any of the preceding embodiments,
placing the washer (1) in an attachment arrangement between the washer (1) and the structure (12),
exerting a crushing force (6) on said washer (1), such that each tooth (13, 15, 16, 17) developing from the conductive projection (3) of the washer (1) scrapes and removes the surface coating (5) of the structure (12), establishing secure and reliable electrical conductivity between the washer (1) and the conductive core (4) of the structure (12). This last step is what is depicted in FIG. 4.

As observed in FIG. 4, the crushing force (6) is exerted in a manner substantially perpendicular to the first plane (7) where the conductive central main body (2) is located.

Advantageously, by applying said crushing force (6) in a perpendicular or substantially perpendicular manner, the amount of force required for the washer to scrape and remove the surface coating from the conductive structure, establishing secure and reliable electrical conductivity between the washer (1) and the conductive core (4) of the structure (12), is reduced.

As shown in FIG. 4, the crushing force (6) must apply the specific rated tightening torque in each case on the washer (1) for the purpose of assuring that the deformable conductive projection and the deformable conductive teeth (3) allow obtaining a planar final geometry of the attachment.

As a result of the design of the washer (1), said washer (1) provides secure and reliable electrical continuity, since its configuration allows scraping the non-conductive surface coating (5) of the structure (12), pushing it out of the contact area, and allowing contact with the conductive core (4) of the structure (12) when a force is applied perpendicular to the first plane (7) of the washer (1).

In other embodiments, the crushing force (6) can be applied obliquely with respect to the first plane (7), for example, in the event that an operator is working in a closed space where they can only exert said crushing force (6) obliquely, for example with an angle of 45° with respect to the first plane (7). As a result of the design of the washer (1), said washer (1) continues to provide secure and reliable electrical conductivity, since the washer is adapted to scrape the non-conductive surface coating (5) of the structure (12) and make contact with the conductive core (4) of the structure (12).

FIG. 5 shows a cross-section view of a washer (1) according to one embodiment after a crushing force (6) has been exerted. It can be seen how at least one serrated conductive projection (3) of the washer (1) assures secure and reliable electrical continuity between the washer (1) and the conductive core (4) of the structure (12). This is because, as seen in further detail in FIG. 6, at least one serrated conductive projection (3) of the washer (1) is in contact with the conductive core (4) of the structure (12), after having scraped off and removed the non-conductive coating (5).

A method of manufacturing the washer according to the present invention is shown below for one embodiment. The method of manufacturing comprises the following steps,
a) Die-cutting a sheet of conductive material with a die-cut tool, in which said die-cut tool comprises a perimetral shape according to the washer (1) of the invention, obtaining a die-cut part with the shape of the washer (1) according to the invention.
b) Deforming the die-cut part in a forging process until obtaining a washer (1) according to the invention. This forging process could be done in a hot or cold forging process.

Advantageously, the technical features of the washer (1) allow manufacturing it in large amounts at a reduced cost and on an industrial level. For example, a die-cutting machine with a die-cut tool with the shape of the washer (1) can be used in the die-cutting process. Additionally different male and female dies can be used in the forging process to define different angles (α). This makes it possible to integrate all the steps in one apparatus or in one production line, which allows manufacturing the different embodiments of the washer (1) in a rapid, efficient and inexpensive manner.

1. A washer for establishing electrical conductivity comprising:
a conductive central main body arranged substantially in a first plane, and comprising:
an opening adapted to receive fastening means, and
an outer edge, and
at least three serrated conductive projections, wherein each serrated projection comprises a first and second end, wherein the first end of the serrated conductive projection is attached to said conductive central main body and the second end is a free end comprising at least one conductive tooth,
wherein the second end of each serrated conductive projection is located in a second plane other than the first plane of the conductive central main body of the washer, said second end being of the type that can deform under pressure, and
wherein the attachment between the conductive central main body and each serrated conductive projection is of the type that can deform under pressure.

2. The washer according to claim 1, wherein each of the second ends of the at least three serrated conductive projections comprises a plurality of teeth.

3. The washer according to claim 1, wherein between the first plane, where the conductive central main body is arranged, and each serrated conductive projection an angle (α) having a value of between 45° and 75°, preferably 60°, is formed.

4. The washer according to claim 3, wherein the angle (α) comprises the same value in each serrated conductive projection.

5. The washer according to claim 1, wherein the at least one conductive tooth comprises a sharp edge, said sharp edge being adapted to scrape a material coming into contact with said at least one conductive tooth.

6. The washer according to claim 1, wherein the first end of each serrated conductive projection is attached to the outer edge of the conductive central main body.

7. The washer according to claim 1, wherein the conductive central main body of the washer is metallic.

8. The washer according to claim 1, wherein the serrated conductive projections of the washer are metallic.

9. The washer according to claim 1, wherein the serrated conductive projections and the conductive central main body form a single part.

10. The washer according to claim 1, wherein the conductive central main body comprises an electrically conductive surface coating.

11. The washer according to claim 1, wherein each serrated conductive projection comprises an electrically conductive surface coating.

12. The washer according to claim 1, wherein the first ends of the serrated conductive projections are distributed equidistantly around the conductive central main body.

13. The washer according to claim 1, wherein the thickness of each serrated conductive projection is constant.

14. The washer according to claim 1, wherein the thickness of each serrated conductive projection is variable.

15. The washer according to claim 1, comprising six serrated conductive projections attached to the conductive central main body.
